(19) United States
(12) Patent Application Publication
(10) Pub. No.: US 2017/0286951 A1
(43) Pub. Date: Oct. 5, 2017

(54) Dynamic Delivery Authorization for Cryptographic Payments

(71) Applicant: Moving Media GmbH, St. Margrethen (CH)

(72) Inventors: Sergey Ignatchenko, Innsbruck-Vill (AT); Bernhard Kaufmann, St. Margrethen (CH)

(21) Appl. No.: 15/165,564

(22) Filed: May 26, 2016

Related U.S. Application Data
(60) Provisional application No. 62/317,633, filed on Apr. 4, 2016.

(51) Int. Cl. G06Q 20/36; G06Q 20/40; G06Q 20/06

(52) U.S. Cl. CPC G06Q 20/3674; G06Q 20/065; G06Q 20/401

(57) ABSTRACT

A dynamic delivery authorization system for cryptographic payments comprising: a merchant cashier system configured to allow a merchant controlling the delivery authorization dynamically in conjunction with cryptographic payment confirmations, an intermediary processing system supporting merchants to accept cryptographic payments from consumers utilizing cryptographic wallets to pay for purchases, a cryptographic payment server configured to receiver purchase request from the cashier system, manage the accrual of cryptocurrency network blockchain confirmations, maintain a merchant configurable, order specific and real-time payment and delivery authorization statuses used by merchant payment and delivery authorization system to authorize the release of tangible and intangible goods and services relative to the risk level set by the merchant for each order placed within the cashier system.

### CROSS REFERENCE TO RELATED APPLICATIONS

10011 This application claims the benefit of U.S. Provisional Application No. 62/317,633, filed on Apr. 4, 2016, titled “Dynamic Delivery Authorization for Cryptographic Payments” which is hereby incorporated by reference in its entirety.

### FIELD OF THE INVENTION

This invention relates to the field of cryptographic payments, specifically, cryptographic payments and delivery systems.

### BACKGROUND

We are living in a close-to-real time world. Purchasers expect delivery instantly after the payment has been executed. Cryptographic payment methods (e.g. Bitcoin) do not necessarily offer instant payments. Block chain transactions based on the Proof-of-Work-protocol (POW) require a certain amount of time for clearing and settlement. Decentralized digital currency uses proof-of-work, peer-to-peer networking, and public-key cryptography to collectively process and verify payments. The clearing and settlement mechanism of cryptographic money transactions such as Bitcoin takes approximately 1 hour to complete. When a transfer is made using cryptographic currency, authorized payments have to be confirmed on the blockchain through participating members (miners) of the crypto currency network before the payment can be deemed as confirmed. In the aforementioned example of crypto currency types, the Bitcoin network recommends 6 confirmations for payments to be deemed fully trustworthy. Bitcoin is known as a peer-to-peer electronic cash system that allows online payments to be sent directly from one party to another without going through a financial institution. Notwithstanding, Bitcoin is not only processed anonymously among peers, it is also processed by regulated financial intermediaries in compliance with Anti-Money-Laundering rules and regulations. In general, cryptocurrencies are mainly used as digital assets that are traded on dedicated crypto exchanges. Within the crypto-network currencies ecosystem funds get bought and sold constantly similar to trading foreign exchange currency on platforms supporting legal tender. In line with its original intent, cryptocurrencies are used as a means of payment for e-commerce transactions as well. Bitcoin for instance serves as an online payment method allowing customers to pay for goods and services purchased from merchants. This use case usually includes conversion from cryptocurrency to legal tender, which is handled by intermediaries such as crypto exchanges or crypto brokers including crypto payment processors.

The financial intermediaries that facilities the crypto currency transaction between the customer and the merchant, sometimes referred to as third-party payment processors for cryptographic payments, in order to reduce risk to the merchant. Typically, merchants do not deem a purchase made by cryptographic payment as “authorized” or “ready for delivery” until all recommended number of block chain confirmations are received by the cryptographic payment processor. The cryptographic payment processors, to facilitate merchant integration, maintain (and sometimes host) merchant payment modules (i.e. Digital Cashier System) that support cryptographic currency as a payment method for ecommerce transactions. The cryptographic payment processors act as financial intermediaries to enable AML-complaint transactions between a consumer and a merchant. Also, their systems mitigate risk between purchasers and merchants. Also, cryptographic payment system managed by cryptographic payment processors have a difficult time in integrating with legacy payment and delivery (logistics) systems which were architected exclusively for non-cryptographic payments.

### SUMMARY

A system that synchronizes the gradual payment authorization process as well as clearing and settlement mechanism inherent to the transaction velocity of crypto payments with an apparatus that allows for dynamic delivery authorizations for tangible/intangible goods and services, which can be utilized by e-commerce distribution systems.

Irrespectively, cryptographic payments are usually trustworthy right after the purchaser has entered the private key to release the cryptographic payment. Payments authorized in this manner can be safely considered as received even with 0 confirmations on the block chain. However, there is no payment guarantee below six confirmations. To manage the risk of rejected payments payees can set the number of confirmations to deem transactions as cleared and settled. As the clearing and settlement process on the block chain is a dynamic procedure and confirmations progress chronologically, merchants have to determine their risk-appetite on their own by setting the number of transactions within their Cashier System client application.

The disclosure does not only emphasize on transaction velocity and the authorization process, and clearing and settlement status of cryptographic payments, instead, we have created a novel system that uniquely addresses the delivery authorization issues in relation to merchant's e-commerce systems and supply chain management.

The disclosure is related to a system which synchronizes payment authorizations originating from blockchain confirmations with third-party e-commerce distribution systems for tangible/intangible goods and services.

The disclosure is novel because it resolves the problems of merchants who are using various third-party e-commerce legacy systems, which are not prepared to deal with uncertainty in regards to payment authorization as well as payment clearing and settlement mechanism associated with cryptographic payments. The disclosure offers a solution not only to transaction velocity but especially to dynamically authorizing products and services for delivery.

The cryptographic payment system provides interfaces that allow merchants to set their delivery authorization dynamically by linking cryptographic payment authorization as well as their payment clearing and settlement status gradually with the requirements of e-commerce distribution systems. The chosen settings are processed via our API, which is tied into the merchant's ecommerce distribution system. These systems can be proprietary or utilize third-party applications such as inventory management systems for tangible goods, allocation systems for virtual goods, digital content distribution services, scheduling systems for personal services, enterprise resource planning systems (ERP), CRM-systems, and CMS-systems.

Our cryptographic payment Cashier System client application enables cryptographic payment processors and merchants to manage and mitigate their default risk in terms of cryptographic payments, and more specifically with regards to losses triggered through misallocation of funds during the course of the supply chain. Another aspect of the Dynamic Delivery Authorization System for Cryptographic Payments allows to authorize payment receipts, approve delivery, and clear and settle transactions incrementally by utilizing the synchronization intervals of the cryptographic payment confirmations on the block chain. Clearing and settlement of funds can be adjusted in the settings of the cryptographic Cashier system by progressively adjusting payment statuses with various delivery statuses of E-commerce distribution systems. This tool enables more efficient forwarding of virtual goods and more effective shipping of physical goods.

### BRIEF DESCRIPTION OF THE DRAWINGS

These and other features will now be described with references to the drawings summarized below. These drawings and the associated description are provided to illustrate a preferred embodiment of the invention, and not to limit the scope of the disclosure.

FIG. 1 is a block diagram illustrating the flow of funds from the consumer to the intermediary, and to the merchant.

FIG. 2 is a functional block diagram of the Dynamic Delivery Authorization System for Cryptographic Payments.

FIG. 3A is a functional block diagram of a first embodiment of the Dynamic Delivery Authorization System for Cryptographic Payments.

FIG. 3B is a functional block diagram of a second embodiment of the Dynamic Delivery Authorization System for Cryptographic Payments.

FIG. 3C is a functional block diagram of a third embodiment of the Dynamic Delivery Authorization System for Cryptographic Payments.

FIG. 4 is a sequence diagram illustrating one embodiment of the payment status of the Dynamic Delivery Authorization System for Cryptographic Payments.

FIG. 5A is a sequence diagram illustrating the first embodiment of the Dynamic Delivery Authorization System for Cryptographic Payments.

FIG. 5B is a sequence diagram illustrating the second embodiment of the Dynamic Delivery Authorization System for Cryptographic Payments.

FIG. 5C is a sequence diagram illustrating the third embodiment of the Dynamic Delivery Authorization System for Cryptographic Payments.

FIG. 6 is a flow diagram illustrating exemplary payment status and the delivery status values.

FIG. 7 is an exemplary flow diagram illustrating a set of exemplary payment status values.

FIG. 8 is an exemplary diagram illustrating the PayByCrypto API, Payment Status API, and the Delivery Status API.

### DETAILED DESCRIPTION

One non-limiting advantage of the Dynamic Delivery Authorization System for Cryptographic Payments (e.g. Bitcoin) to synchronize blockchain confirmations between payment clearing statuses of Payment Service Providers' backend processing engines and delivery clearance methods of E-commerce distribution systems. The proprietary mechanics of the payment service provider's backend system supports a method to authorize cryptographic payments in synchronization with blockchain confirmations for clearing and settlement of funds in reconciliation with various delivery statuses progressively adjustable for forwarding virtual goods and shipping of physical goods purchased through E-commerce applications utilizing Industry-specific distribution systems.

Another non-limiting advantage of the Dynamic Delivery Authorization System for Cryptographic Payments is a tool that allows crypto currency such as Bitcoin to be available immediately upon receipt, and in some cases, like merchant verticals for virtual goods, eliminating the need to wait for confirmations until delivery authorizations can be forwarded to e-commerce distribution systems. Typical Bitcoin transactions take 10 minutes or more to be recorded in a block by miners. Until confirmed in the blockchain, transactions are known as “zero-confirm” transactions and are unsafe to rely on. This is because, it is possible for the sender to spend the money elsewhere before the transaction is confirmed. As a result, merchants accepting Bitcoin require multiple confirmations to credit a payment as received, which can take anywhere from a few minutes to several hours. With our Dynamic Delivery Authorization System for Cryptographic Payments, funds can be regarded as received right after the payment authorization and/or after a low number of confirmations, hence, orders can be processed for delivery faster than usual.

Nevertheless, this feature does not prevent double spend attacks, which occur when a sender spends money elsewhere before the blockchain confirms the transaction. Therefore, merchants using our acceptance modules are not compensated in the event that their transaction is not confirmed by the blockchain and losses are incurred as a result. Moving Media GmbH, the owner of the Payment21-brand, operates as a financial intermediary offering the Dynamic Delivery Authorization System for Cryptographic Payments on www.payment21.com. The financial intermediary is not liable for the successful receipt of transactions. Merchants assume risk if Bitcoin payments do not get confirmed through the blockchain. The liability remains with the merchants who are free to set the number of confirmations as per their business needs. Using the application is free for incoming transactions for consumers and merchants.

This acceptance and delivery authorization mechanism is beneficial for merchants due to the unpredictable rate of block creation by miners. While merchants would usually need to wait for several minutes or even several hours to receive a transaction confirmation, merchants can classify their payment as received and in a second step regard the payment as sufficiently cleared into their settlement account hosted by the payment service provider. Having the option to set funds as cleared as per merchant's business requirements allows them to fill orders faster and have the products and services released for delivery earlier. Merchants utilizing the Dynamic Delivery Authorization System for Cryptographic Payments benefit from increased velocity of payments, and as a result, they have more working capital available.

Traditional payment service providers offering ACH or card processing have totally different payment acceptance mechanisms in relation to the requirements of merchant's ecommerce systems. Synchronizing clearing statuses of payments with delivery clearance of orders is usually included in order processing policies of logistic service providers and merchants. Having an application controlling and synchronizing payment statuses with delivery clearance is new.

Legacy online payment methods, like ACH-payments or credit card payments use different authorization methods and divergent clearing and settlement mechanisms to process funds on behalf of merchants. They are different because it is not possible to trace payments publicly like it can be done through the blockchain. In addition, the counterparty risk of regular bank-driven payments cannot be mitigated through tracking payments through public witnesses who make an effort to reach consensus by confirming the true existence of the transaction. Today's banking systems do not allow public tracing of payments in close-to-real-time. Therefore, merchants have to rely on fraud prevention systems, payment guarantees of third-parties, and accept the counterparty risk that is enforced by ACH-processing banks and card payment acquiring banks. However, traditional online payment methods recommend merchants to regard a payment as received as soon as an authorization is received, and classify products and services as being ready for delivery once funds are confirmed as cleared by the bank, which usually happens within 1-3 business days. Final settlement payments are usually made within 1-4 weeks, whereby bounced checks and chargebacks are deducted.

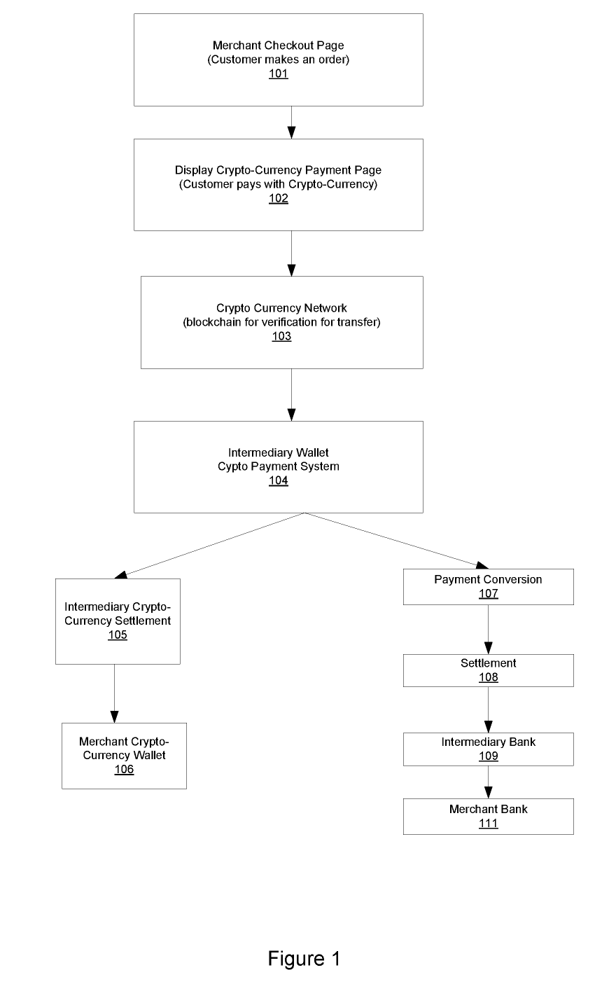

Exemplary embodiments of the disclosure are described below in further detail in connection with FIGS. 1-8.

Specific embodiments will now be described with reference to the drawings. These embodiments are intended to illustrate and not limit the present disclosure. In accompanying drawings, common elements are commonly numbered in the respective views. Numeric identifiers are provided below as a quick reference guide.

FIG. 1 is a block diagram illustrating the flow of funds from the customer 110, to the intermediary, and to the merchant. In Step 101, the merchant checkout page wherein the customer initiates a request to place an order and pay via cryptographic payment. In Step 102, the consumer is displayed with the crypto currency payment page, wherein the order finalized in a form of legal tender (i.e. US currency) is converted (via an API call to a crypto currency exchange servers) to its crypto currency conversion value so that the customer is aware of the actual cost of the transaction in the form of the crypto currency, wherein the customer uses the customer crypto wallet to pay for the order with crypto currency attached to his crypto wallet. The customer enters his private key in order to initiate the transfer of the crypto currency from his customer crypto wallet to the intermediary wallet. In Step 103, the crypto currency network (i.e. Bitcoin network) performs the task of initiating miners to verify payment transactions whereby the transfer of access rights to the crypto currency from the customer wallet to the intermediary is witnessed wherein the blockchain confirmation process takes place, and wherein miners are paid a fee to confirm the transaction history of the crypto currency used for the order. In this context, the crypto daemon operated on a dedicated server of the financial intermediary is on standby. Other peers (Bitcoin nodes) broadcast the blocks containing payment transactions to the network as per Bitcoin protocol requirements. Miners run Bitcoin full nodes and broadcast the transactions respectively pushing payment confirmations to the network while the intermediary receives the confirmed transactions automatically since the crypto daemon of the intermediary is on unattended reception monitoring and pulling in confirmations from miners.

In Step 104, the crypto currency network transfers blockchain confirmations to the intermediary wallet as soon as the each of the miners confirms each of the x number of blockchain confirmations (i.e. the Bitcoin protocol recommends 6 blockchain confirmations) required to authorize (or confirm) the payment. The proceeding steps are completed in parallel: Step 105 and Step 107. In Step 105, the intermediary wallet, after receiving all required confirmations, initiates settlement. In Step 106, the funds are transferred from the intermediary wallet to the merchant crypto currency wallet. In Step 107, the payment conversion takes place, where a sell order is placed on a crypto currency exchange market to retrieve the highest value, a real time payment conversion from crypto currency to legal tender in a currency of the merchant's choice is requested. In Step 108, the legal tender resulting from the payment conversion is considered settled. In Step 108, the settled legal tender is transferred to the intermediary bank holdings. In Step 109, the settled legal tender held in the intermediary bank holdings is finally transferred to the merchant bank holdings, and the process is completed.

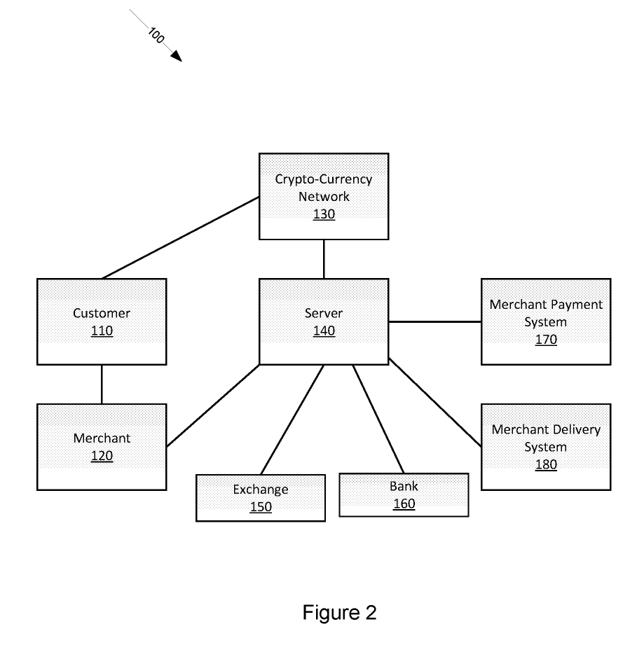

FIG. 2 is a functional block diagram of the Dynamic Delivery Authorization System for Cryptographic Payments. In one embodiment of the disclosure, the Dynamic Delivery Authorization System for Cryptographic Payments 100 may utilize a client-server architecture whereby the customer interacts with the server components by means of a client application which transmits requests to the server system. Moreover, the Dynamic Delivery Authorization System for Cryptographic Payments 100 may utilize a client-server architecture whereby the external merchant payment system and external merchant delivery system utilize specific application program interfaces (API's) to interact with the server. The Dynamic Delivery Authorization System for Cryptographic Payments 100 is comprised of multiple components enumerated herein as: Customer 110, Merchant 120, Server 140, Crypto-Currency Network 130, Crypto-Exchange 150, Bank 160, Merchant Payment System 170, and Merchant Delivery System 180. The Dynamic Delivery Authorization System for Cryptographic Payments 100 may leverage proprietary API's enumerated in the Payment21 Application Programming Interface technical document which is incorporated by reference herein, which comprise exemplary application programming interfaces as described in the proceeding figures.

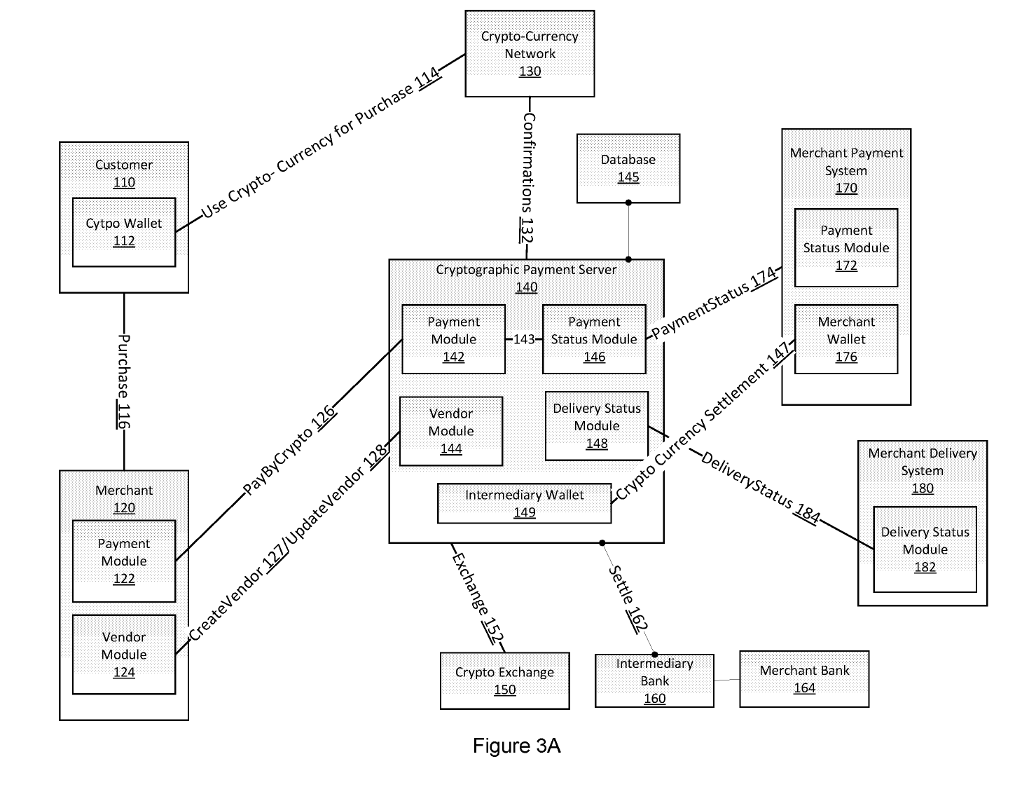

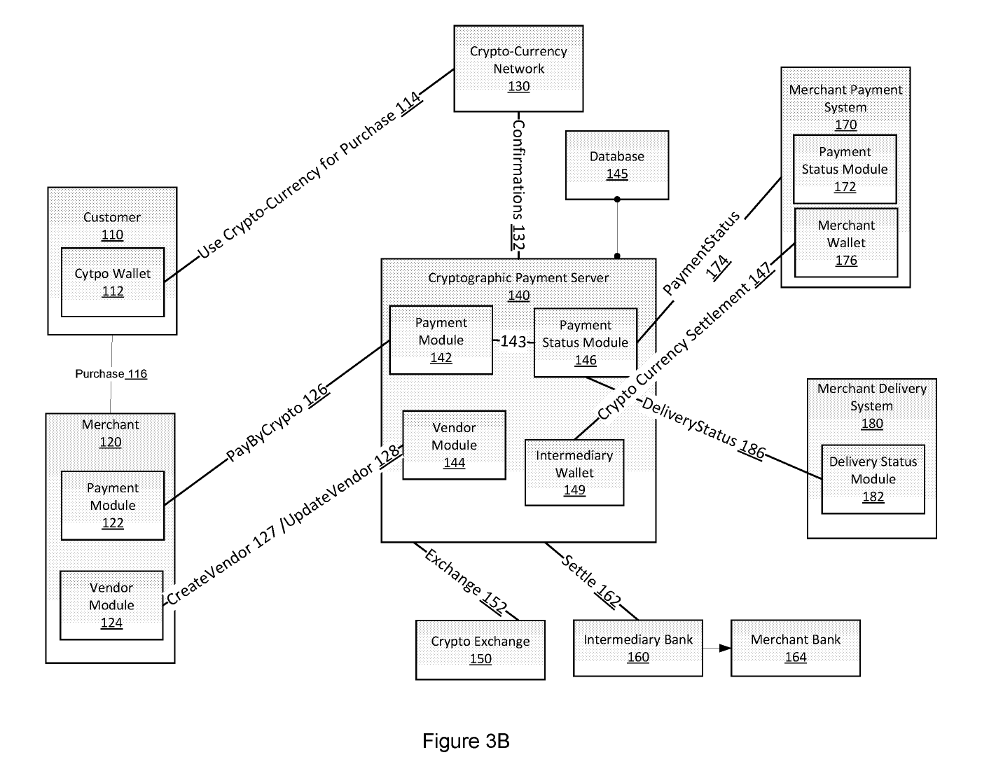

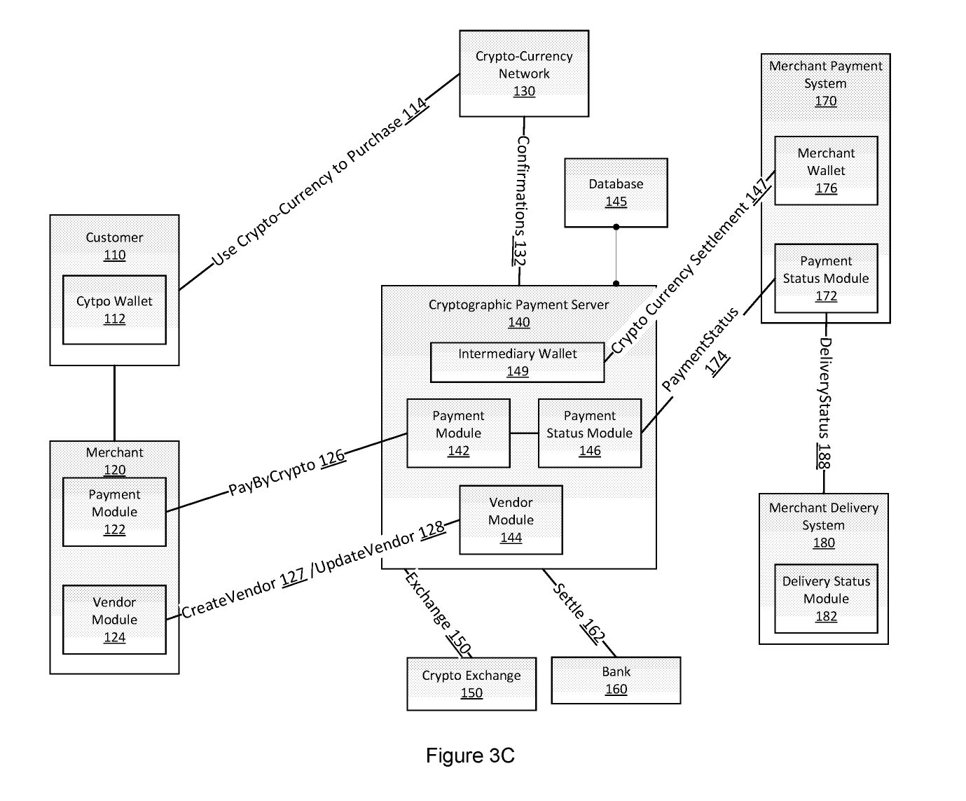

FIG. 3A is a functional block diagram of one embodiment of the Dynamic Delivery Authorization System for Cryptographic Payments. In one embodiment, the customer 110 having a customer crypto wallet is interested in making a purchase. In one embodiment of the disclosure, a customer 110 initiates a purchase request and would like to proceed with the transaction using crypto currency rather than legal tender. The customer 110 would use the merchant provided check out page hosted either by the merchant 120 or the cryptographic payment server 140. The customer 110 having a cryptographic wallet containing cryptographic currency stored therein (i.e. Crypto Wallet) would initiate the purchase by entering a private key associated with the customer cryptographic wallet 112 in order to authorize the transfer of crypto currency from the crypto wallet 112 to the cryptographic payment server 140 having an intermediary cryptographic wallet 149. The customer 110 makes a purchase 116 when the customer 110 completion of entering his private keys into the merchant payment module 122. In addition, in parallel with the purchase 116 request, the customer crypto currency wallet 112 will submit a use crypto currency for purchase 114 request to the crypto currency network 130 to initiate the process of verifying the transfer of access rights to the crypto currency through blockchain confirmations equivalent to mining by peers operating Bitcoin nodes. Miners are paid a minimal fee to verify the transaction. The crypto currency network 130 transmits blockchain confirmations 132 for the crypto currency purchase request as soon as they are completed by the miners to the cryptographic payment server 140. In one exemplary embodiment, the Cryptographic Payment Server 140 may comprise a cryptocurrency daemon application (not shown) on standby. Other peers (Bitcoin nodes) broadcast the blocks containing transactions to the network as per Bitcoin protocol. Miners use powerful devices to run Bitcoin full nodes and broadcast (“PUSH”) the transactions respectively confirmations to the network while the Cryptographic Payment Server 140 receive them automatically. This may be referred to as “unattended reception” or “PULL”. Thus, the crypto currency confirmation may be communicated between the crypto currency network 130 and the cryptographic payment server 140 by means of either a “Push” or “Pull” mechanism.

In order for the merchant to set up the payment module 122, the merchant had to pre-configure his account profile with the cryptographic payment server 140 by utilizing a CreateVendor API 127 wherein the merchant input information specific to his business in order to setup an account with the cryptographic payment server 140. In addition, the vendor module 124 allows the merchant to update his vendor account profile with the cryptographic payment server 140 by utilizing a UpdateVendor API 128 wherein the merchant updates information previously specified in the CreateVendor API 127 in the instance that it needs to be updated. In order for the merchant to authenticate the request, the merchant must provide his Merchant ID and API Key in every request sent to the cryptographic payment server 140. The merchant vendor module 124 communicates with the server vendor module 124 by means of at least two API's, namely, the CreateVendor API 127 and the UpdateVendor API 128. The server vendor module 144 transmits information received to the database 145 for storage and request initiated by other modules within the cryptographic payment server 140.

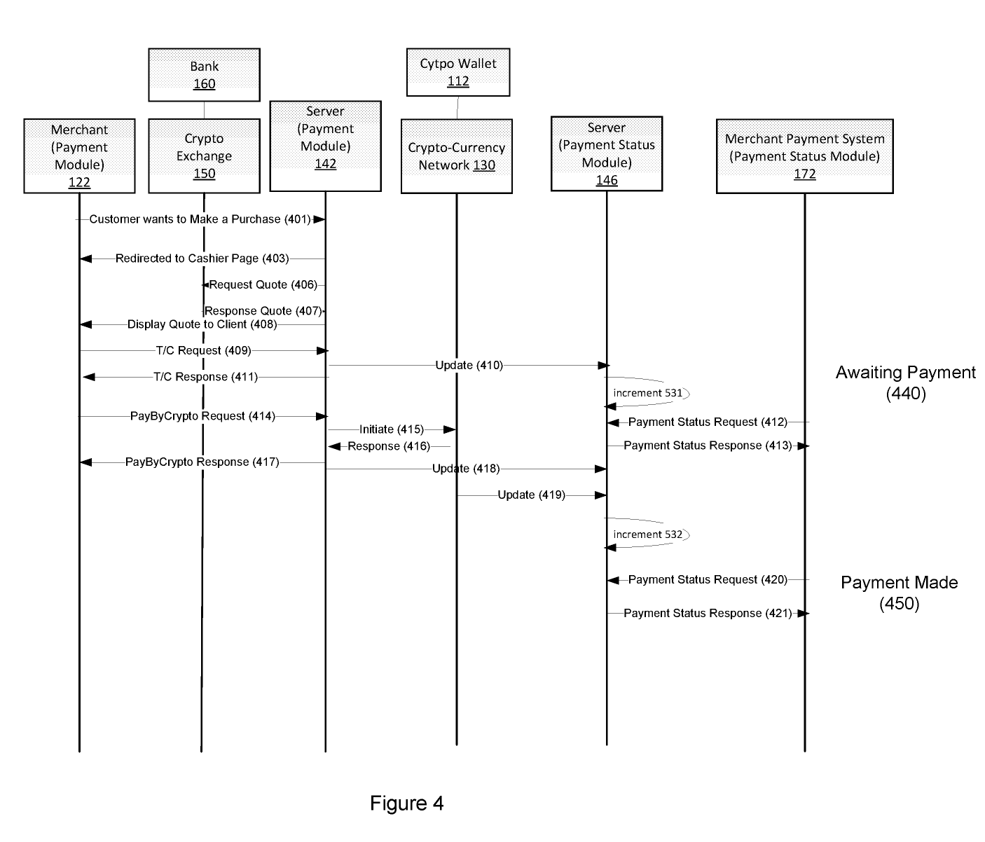

Upon the Customer 110 authorizing the purchase by entering his private keys to transfer the funds from his crypto wallet 112 to the intermediary wallet 149, a PayByCrypto API 126 is used by the merchant vendor to transmit a PayByCrypto Request 414 as shown in FIG. 4. The PayByCrypto Request 414 may contain a Merchant ID, a Merchant API Key, a Vendor ID, an Order Amount, an Order Currency, an Item Description, an Item Code, a Merchant Customer ID, parameters related to Customer Information, a Delivery Level (associated with Delivery Authorization), and a Payment Authorization Level (associated with Payment Authorization). In response the PayByCrypto request 414, the cryptographic payment server 140 will transmit a PayByCrypto Response 417 as shown in FIG. 4 which may contain a transaction ID and a Redirect URL for which the customer 110 will be redirected to. The merchant payment module 122 communicates with the server payment module 142 directly by using the PayByCrypto API 126. The information gathered from at least one transaction handled by the server payment module 142 is communicated to a database 145 for archival and later retrieval. The server payment module 142 receives a PayByCrypto request 414, and responds with a PayByCrypto response 417 to the merchant payment module 122. Furthermore, the server payment module 142 writes to the database 145 information it received from the PayByCrypto request 414 and makes available 143 a sub-set of this information with the server payment module 146.

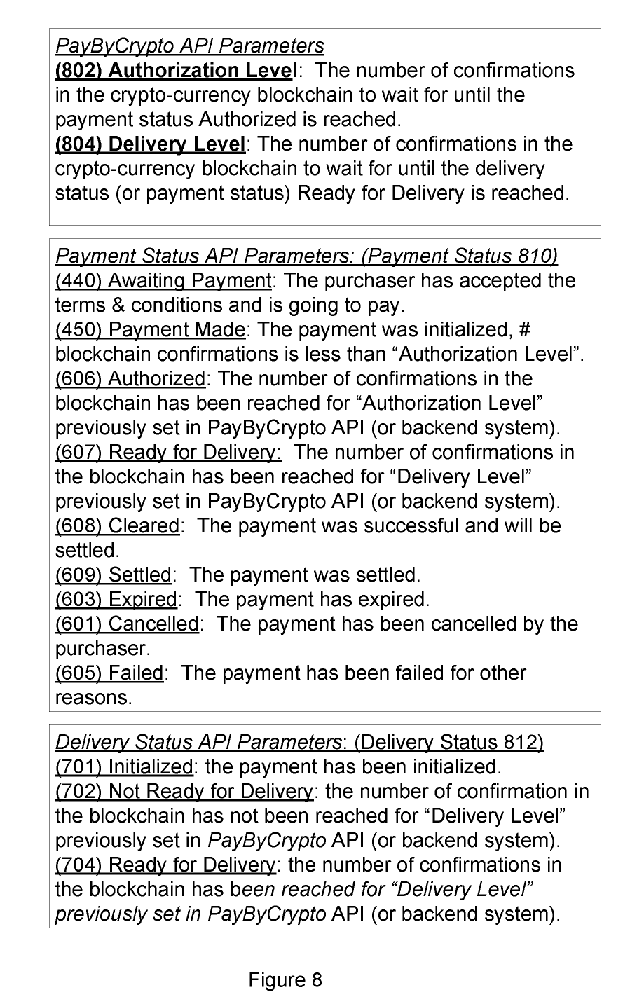

The server payment status module 146 communicates with the database 145, the payment module 145, and the external Crypto-Currency Network 130 in order to gather appropriate information regarding the processed transaction in order to convey to an external merchant payment system 170 an accurate payment status related to the processed purchase transaction. The server payment status module 146 is configured to initialize a payment status for the purchase transaction made by the customer 110 whereby the payment status is reflective of the real-time status of the transaction in process. In one embodiment, the payment status begins at “awaiting payment”, and then user agrees to the Cashier System terms and conditions. Moreover, as the customer 110 decides to make the purchase by inputting his crypto currency private key for authentication purposes, then the status changes to “payment made”. When the payment is made by the customer 110 the blockchain confirmation count is 0, and the process of verifying and transferring blockchain confirmations to the intermediary wallet 149 begins. The intermediary wallet 149 and the payment status module 146 gradually receives blockchain confirmations from the crypto currency network 130 related to the purchase made by the customer 110 over a time range period, between a few minutes to a few hours with a typical minimum of 10 minutes and a maximum of 1 hour in duration. As the numbers of blockchain confirmations gradually received begin to accrue the payment status is modified to reflect the real time payment status of the purchase transaction. The payment status may be incremented to “authorized” at the moment when the number of confirmations in the blockchain has reached a value equal or greater to the Payment Authorization Level 802 as shown in FIG. 8. When all required confirmations on the blockchain are received (typically 6 for Bitcoin), then the payment status is incremented to “Cleared”. Thereafter, the payment status module initiates the process of settlement by interacting by means of an Exchange API 152 with the crypto exchange 150 place a sell order to request a currency conversion from crypto currency to legal tender and in parallel initiates a settlement API 162 to settle the purchase transaction with an intermediary bank 160 and finally settle the funds with the merchant bank 164. Moreover, the intermediary wallet 149 will initiate an API call to settle the crypto currency with the merchant wallet residing within the merchant payment system 170.

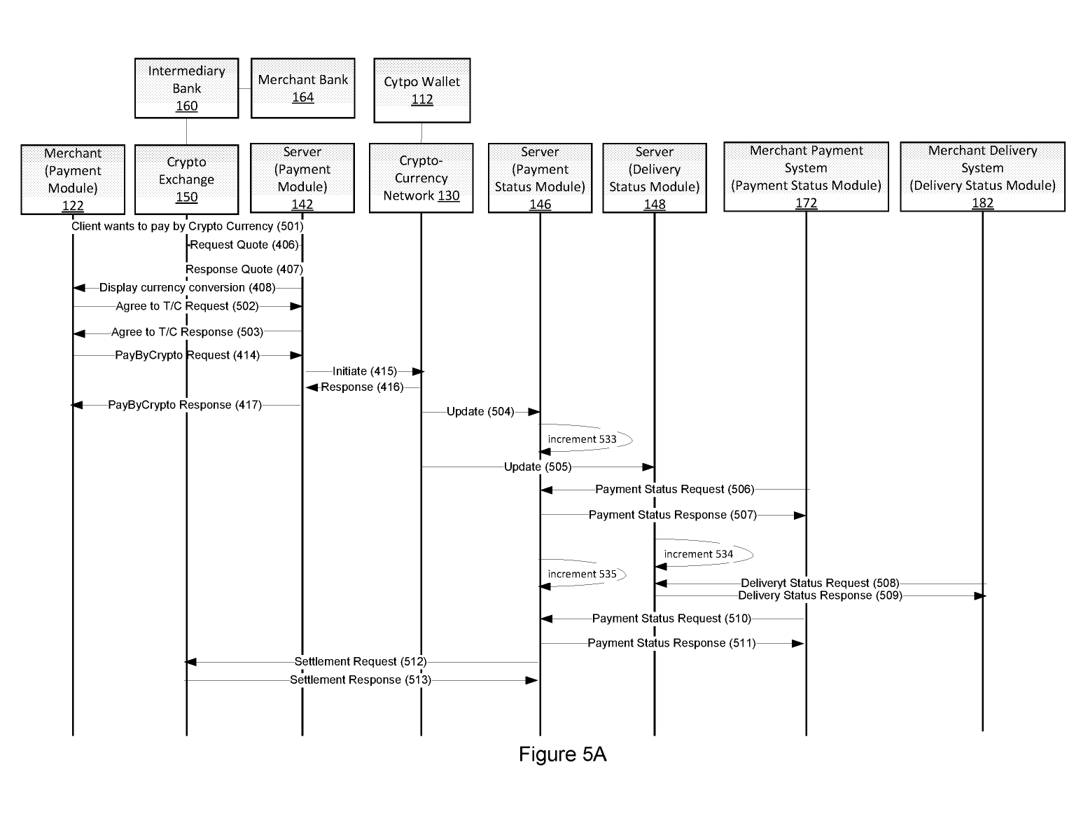

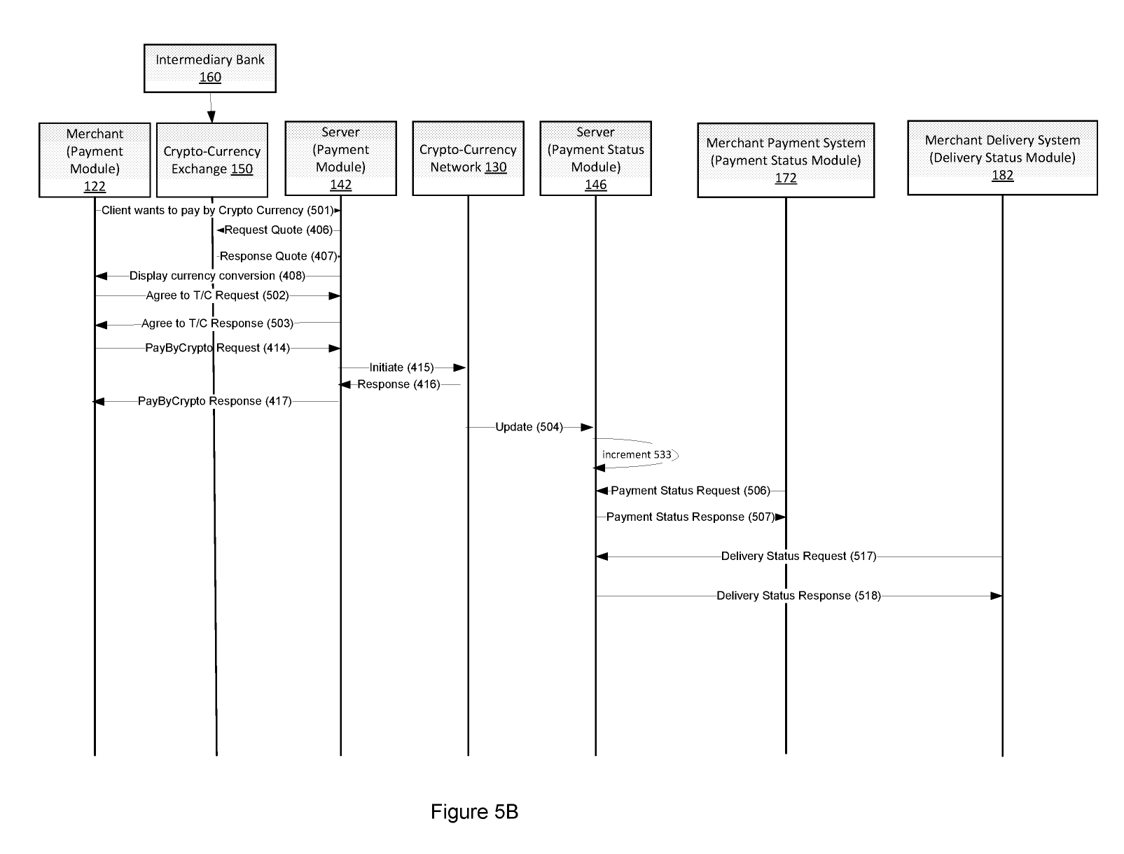

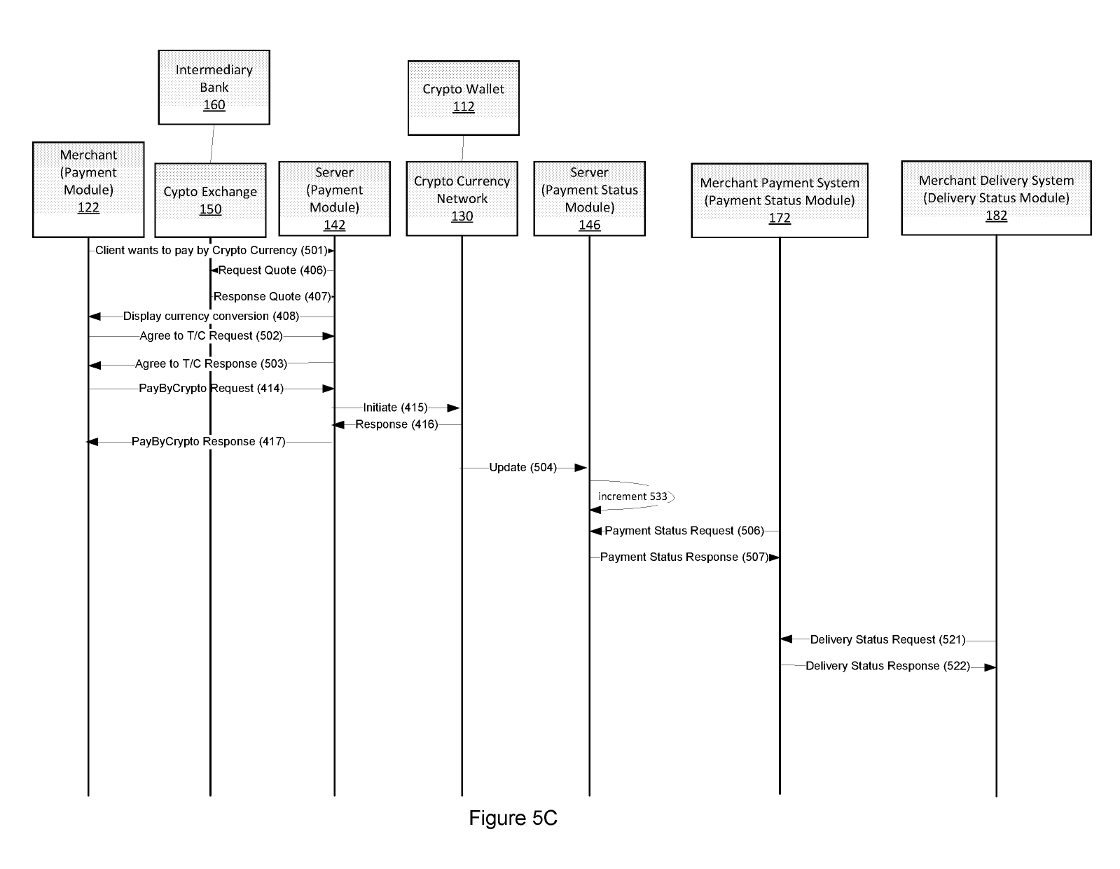

In order for the external Merchant Payment System 170 to know that the payment status value 810 as shown in FIG. 8, the Merchant Payment Status Module 172 uses a Payment Status API 174 to transmits a Payment Status Request as shown in FIG. 5A and receives a Payment Status Response as shown in FIG. 5A. The Payment Status Request requests the Payment Status 810 as shown in FIG. 8 from the Server Payment Status Module 146, while the Payment Status Response provides the Payment Status 810 value as requested by the Merchant Payment Status Module 172.

The server delivery status module 148 communicates with the database 145 and the external Crypto-Currency Network 130 in order to gather appropriate information regarding the processed transaction in order to convey to an external merchant delivery system 180 an accurate delivery status related to the processed purchase transaction. The server delivery status module 148 is configured to initialize a delivery status for the purchase transaction made by the customer 110 whereby the delivery status is reflective of the real-time status of the transaction in process. In one embodiment, the delivery status begins at “initialized”. When the payment is made by the customer 110 the blockchain confirmation count is 0, and the process of verifying and transferring blockchain confirmations to the intermediary wallet 149 begins. The delivery status is modified to “Not Ready for Delivery” when the blockchain confirmation count is 0 and this status of “Not Ready for Delivery” is maintained until the intermediary wallet 149 and the delivery status modules 148 both receive from the Crypto-Currency Network 130 a blockchain confirmation value of less than the Delivery Level 804 (as described in FIG. 8) amount set in the PayByCrypto API previously received by the server payment module 142. The intermediary wallet 149 and the payment status module 146 gradually receives blockchain confirmations from the crypto currency network related to the purchase made by the customer 110 over a time range period, typically between a few minutes to a few hours with a typical minimum of 10 minutes and a maximum of 1 hour in duration. As the numbers of blockchain confirmations gradually received begin to accrue the delivery status is modified to reflect the real time delivery status of the purchase transaction. The delivery status may be incremented to “Ready for Delivery” at the moment when the number of confirmations in the blockchain has reached a value equal or greater to the Delivery Level 804 as shown in FIG. 8. When all required confirmations on the blockchain are received (i.e. typically 6 for Bitcoin), then the Delivery Status is fixed to “Ready for Delivery”. In order for the external Merchant Delivery System 182 to know that the delivery status value 812 as shown in FIG. 8, the Merchant Delivery Status Module 182 uses a Delivery Status API 184 to transmits a Delivery Status Request 508 as shown in FIG. 5A and receives a Delivery Status Response 509 as shown in FIG. 5A. The Delivery Status Request 508 requests the Delivery Status 812 as shown in FIG. 8 from the Server Delivery Status Module 148, while the Delivery Status Response 509 provides the Delivery Status 812 value as requested by the Merchant Delivery Status Module 182.

FIG. 3B is a functional block diagram of one embodiment of the Dynamic Delivery Authorization System for Cryptographic Payments. In one embodiment, the customer 110 having a customer crypto wallet is interested in making a purchase. In one embodiment of the disclosure, a customer 110 initiates a purchase request and would like to proceed with the transaction using crypto currency rather than legal tender. The customer 110 would use the merchant provided check out page hosted either by the merchant 120 or the cryptographic payment server 140. The customer 110 having a cryptographic wallet containing cryptographic currency stored therein (i.e. Crypto Wallet) would initiate the purchase by entering a private key associated with the customer cryptographic wallet 112 in order to authorize the transfer of crypto currency from the crypto wallet 112 to the cryptographic payment server 140 having an intermediary cryptographic wallet 149. The customer 110 makes a purchase 116 when the customer 110 completion of entering his private keys into the merchant payment module 122. In addition, in parallel with the purchase 116 request, the customer crypto currency wallet 112 will submit a use crypto currency for purchase 114 request to the crypto currency network 130 to initiate the process of verifying the transfer of access rights to the crypto currency through blockchain confirmations equivalent to mining by peers operating Bitcoin nodes. Miners are paid a minimal fee to verify the transaction. The crypto currency network 130 transmits blockchain confirmations 132 for the crypto currency purchase request as soon as they are completed by the miners to the cryptographic payment server 140.

In order for the merchant to set up the payment module 122, the merchant had to pre-configure his account profile with the cryptographic payment server 140 by utilizing a CreateVendor API 127 wherein the merchant input information specific to his business in order to setup an account with the cryptographic payment server 140. In addition, the vendor module 124 allows the merchant to update his vendor account profile with the cryptographic payment server 140 by utilizing a UpdateVendor API 128 wherein the merchant updates information previously specified in the CreateVendor API 127 in the instance that it needs to be updated. In order for the merchant to authenticate the request, the merchant must provide his Merchant ID and API Key in every request sent to the cryptographic payment server 140. The merchant vendor module 124 communicates with the server vendor module 124 by means of at least two API's, namely, the CreateVendor API 127 and the UpdateVendor API 128. The server vendor module 144 transmits information received to the database 145 for storage and request initiated by other modules within the cryptographic payment server 140.

Upon the Customer 110 authorizing the purchase by entering his private keys to transfer the funds from his crypto wallet 112 to the intermediary wallet 149, a PayByCrypto API 126 is used by the merchant vendor to transmit a PayByCrypto Request 414 as shown in FIG. 4. The PayByCrypto Request 414 may contain a Merchant ID, a Merchant API Key, a Vendor ID, an Order Amount, an Order Currency, an Item Description, an Item Code, a Merchant Customer ID, parameters related to Customer Information, a Delivery Level 804 (associated with Delivery Authorization), and a Payment Authorization Level 802 (associated with Payment Authorization). In response the PayByCrypto request 414, the cryptographic payment server 140 will transmit a PayByCrypto Response 417 as shown in FIG. 4 which may contain a transaction ID and a Redirect URL for which the customer 110 will be redirected to. The merchant payment module 122 communicates with the server payment module 142 directly by using the PayByCrypto API 126. The information gathered from at least one transaction handled by the server payment module 142 is communicated to a database 145 for archival and later retrieval. The server payment module 142 receives a PayByCrypto request 414, and responds with a PayByCrypto response 417 to the merchant payment module 122. Furthermore, the server payment module 142 writes to the database 145 information it received from the PayByCrypto request 414 and makes available 143 a sub-set of this information with the server payment module 146.

The server payment status module 146 communicates with the database 145, the payment module 145, and the external Crypto-Currency Network 130 in order to gather appropriate information regarding the processed transaction in order to convey to an external merchant payment system 170 an accurate payment status related to the processed purchase transaction. The server payment status module 146 is configured to initialize a payment status for the purchase transaction made by the customer 110 whereby the payment status is reflective of the real-time status of the transaction in process. In one embodiment, the payment status begins at “awaiting payment”, and then user agrees to the Cashier System terms and conditions or purchase conditions. Moreover, as the customer 110 decides to make the purchase by inputting his crypto currency private key for authentication purposes, then the status changes to “payment made”. When the payment is made by the customer 110 the blockchain confirmation count is 0, and the process of verifying and broadcasting blockchain confirmations to the intermediary wallet 149 begins. The intermediary wallet 149 and the payment status module 146 gradually receives blockchain confirmations from the crypto currency network related to the purchase made by the customer 110 over a time range period, between a few minutes to a few hours with a typical minimum of 10 minutes and a maximum of 1 hour in duration. As the numbers of blockchain confirmations gradually received begin to accrue the payment status is modified to reflect the real time payment status of the purchase transaction. The payment status may be incremented to “authorized” at the moment when the number of confirmations in the blockchain has reached a value equal or greater to the Payment Authorization Level 802 as shown in FIG. 8. When all required confirmations on the blockchain are received (typically 6 for Bitcoin), then the payment status is incremented to “Cleared”. Thereafter, the payment status module initiates the process of settlement by interacting by means of an Exchange API 152 with the crypto exchange 150 place a sell order to request a currency conversion from crypto currency to legal tender and in parallel initiates a settlement API 162 to settle the purchase transaction with an intermediary bank 160 and finally settle the funds with the merchant bank 164. Moreover, the intermediary wallet 149 will initiate an API call to settle the crypto currency with the merchant wallet residing within the merchant payment system 170.

In order for the external Merchant Payment System 170 to know that the payment status value 810 as shown in FIG. 8, the Merchant Payment Status Module 172 uses a Payment Status API 174 to transmits a Payment Status Request 515 as shown in FIG. 5B and receives a Payment Status Response 516 as shown in FIG. 5B. The Payment Status Request requests the Payment Status 810 as shown in FIG. 8 from the Server Payment Status Module 146, while the Payment Status Response 516 provides the Payment Status 810 value as requested by the Merchant Payment Status Module 172.

The server payment status module 146 communicates with the database 145 and the external Crypto-Currency Network 130 in order to gather appropriate information regarding the processed transaction in order to convey to an external merchant delivery system 180 an accurate delivery status related to the processed purchase transaction. The server payment status module 146 is configured to initialize a delivery status for the purchase transaction made by the customer 110 whereby the delivery status is reflective of the real-time status of the transaction in process. In one embodiment, the delivery status begins at “initialized”. When the payment is made by the customer 110 the blockchain confirmation count is 0, and the process of verifying and transferring blockchain confirmations to the intermediary wallet 149 begins. The delivery status is modified to “Not Ready for Delivery” when the blockchain confirmation count is 0 and this status of “Not Ready for Delivery” is maintained until the intermediary wallet 149 and the delivery status modules 148 both receive from the Crypto-Currency Network 130 a blockchain confirmation value of less than the Delivery Level 804 (as shown in FIG. 8) amount set in the PayByCrypto API previously received by the server payment module 142. The intermediary wallet 149 and the payment status module 146 gradually receives blockchain confirmations from the crypto currency network related to the purchase made by the customer 110 over a time range period, between a few minutes to a few hours with a typical minimum of 10 minutes and a maximum of 1 hour in duration. As the numbers of blockchain confirmations gradually received begin to accrue the delivery status is modified to reflect the real time delivery status of the purchase transaction. The delivery status may be incremented to “Ready for Delivery” at the moment when the number of confirmations in the blockchain has reached a value equal or greater to the Delivery Level 804 as shown in FIG. 8. When all required confirmations on the blockchain are received (typically 6 for Bitcoin), then the Delivery status is fixed to “Ready for Delivery”.

In order for the external Merchant Delivery System 182 to know that the delivery status value 812 as shown in FIG. 8, the Merchant Delivery Status Module 182 uses a Delivery Status API 186 to transmits a Delivery Status Request 517 as shown in FIG. 5B and receives a Delivery Status Response 518 as shown in FIG. 5B. The Delivery Status Request 517 requests the Delivery Status 812 as shown in FIG. 8 from the Server Payment Status Module 146, while the Delivery Status Response 518 provides the Delivery Status 812 value as requested by the Merchant Delivery Status Module 182.

FIG. 3C is a functional block diagram of one embodiment of the Dynamic Delivery Authorization System for Cryptographic Payments. In one embodiment, the customer 110 having a customer crypto wallet is interested in making a purchase. In one embodiment of the disclosure, a customer 110 initiates a purchase request and would like to proceed with the transaction using crypto currency rather than legal tender. The customer 110 would use the merchant provided check out page hosted either by the merchant 120 or the cryptographic payment server 140. The customer 110 having a cryptographic wallet containing cryptographic currency stored therein (i.e. Crypto Wallet) would initiate the purchase by entering a private key associated with the customer cryptographic wallet 112 in order to authorize the transfer of crypto currency from the crypto wallet 112 to the cryptographic payment server 140 having an intermediary cryptographic wallet 149. The customer 110 makes a purchase 116 when the customer 110 completion of entering his private keys into the merchant payment module 122. In addition, in parallel with the purchase 116 request, the customer crypto currency wallet 112 will submit a use crypto currency for purchase 114 request to the crypto currency network 130 to initiate the process of verifying the transfer of access rights to the crypto currency through blockchain confirmations equivalent to mining by peers operating Bitcoin nodes. Miners are paid a minimal fee to verify the transaction. The crypto currency network 130 transmits blockchain confirmations 132 for the crypto currency purchase request as soon as they are completed by the miners to the cryptographic payment server 140.

In order for the merchant to set up the payment module 122, the merchant had to pre-configure his account profile with the cryptographic payment server 140 by utilizing a CreateVendor API 127 wherein the merchant input information specific to his business in order to setup an account with the cryptographic payment server 140. In addition, the vendor module 124 allows the merchant to update his vendor account profile with the cryptographic payment server 140 by utilizing a UpdateVendor API 128 wherein the merchant updates information previously specified in the CreateVendor API 127 in the instance that it needs to be updated. In order for the merchant to authenticate the request, the merchant must provide his Merchant ID and API Key in every request sent to the cryptographic payment server 140. The merchant vendor module 124 communicates with the server vendor module 124 by means of at least two API's, namely, the CreateVendor API 127 and the UpdateVendor API 128. The server vendor module 144 transmits information received to the database 145 for storage and request initiated by other modules within the cryptographic payment server 140.

Upon the Customer 110 authorizing the purchase by entering his private keys to transfer the funds from his crypto wallet 112 to the intermediary wallet 149, a PayByCrypto API 126 is used by the merchant vendor to transmit a PayByCrypto Request 414 as shown in FIG. 4. The PayByCrypto Request 414 may contain a Merchant ID, a Merchant API Key, a Vendor ID, an Order Amount, an Order Currency, an Item Description, an Item Code, a Merchant Customer ID, parameters related to Customer Information, a Delivery Level (associated with Delivery Authorization), and a Payment Authorization Level (associated with Payment Authorization). In response the PayByCrypto request 414, the cryptographic payment server 140 will transmit a PayByCrypto Response 417 as shown in FIG. 4 which may contain a transaction ID and a Redirect URL for which the customer 110 will be redirected to. The merchant payment module 122 communicates with the server payment module 142 directly by using the PayByCrypto API 126. The information gathered from at least one transaction handled by the server payment module 142 is communicated to a database 145 for archival and later retrieval. The server payment module 142 receives a PayByCrypto request 414, and responds with a PayByCrypto response 417 to the merchant payment module 122. Furthermore, the server payment module 142 writes to the database 145 information it received from the PayByCrypto request 414 and makes available 143 a sub-set of this information with the server payment module 146.

The server payment status module 146 communicates with the database 145, the payment module 145, and the external Crypto-Currency Network 130 in order to gather appropriate information regarding the processed transaction in order to convey to an external merchant payment system 170 an accurate payment status related to the processed purchase transaction. The server payment status module 146 is configured to initialize a payment status for the purchase transaction made by the customer 110 whereby the payment status is reflective of the real-time status of the transaction in process. In one embodiment, the payment status begins at “awaiting payment”, and as the user agrees to the Cashier System terms and conditions or purchase conditions. Moreover, as the customer 110 decides to make the purchase by inputting his crypto currency private key for authentication purposes, then the status changes to “payment made”. When the payment is made by the customer 110 the blockchain confirmation count is 0, and the process of verifying and transferring blockchain confirmations to the intermediary wallet 149 begins. The intermediary wallet 149 and the payment status module 146 gradually receives blockchain confirmations from the crypto currency network related to the purchase made by the customer 110 over a time range period, between a few minutes to a few hours with a typical minimum of 10 minutes and a maximum of 1 hour in duration. As the numbers of blockchain confirmations gradually received begin to accrue the payment status is modified to reflect the real time payment status of the purchase transaction. The payment status may be incremented to “authorized” at the moment when the number of confirmations in the blockchain has reached a value equal or greater to the Payment Authorization Level 802 as shown in FIG. 8. When all required confirmations on the blockchain are received (typically 6 for Bitcoin), then the payment status is incremented to “Cleared”. Thereafter, the payment status module initiates the process of settlement by interacting by means of an Exchange API 152 with the crypto exchange 150 place a sell order to request a currency conversion from crypto currency to legal tender and in parallel initiates a settlement API 162 to settle the purchase transaction with an intermediary bank 160 and finally settle the funds with the merchant bank 164. Moreover, the intermediary wallet 149 will initiate an API call to settle the crypto currency with the merchant wallet residing within the merchant payment system 170.

In order for the external Merchant Payment System 170 to know that the payment status value 810 as shown in FIG. 8, the Merchant Payment Status Module 172 uses a Payment Status API 174 to transmits a Payment Status Request 519 as shown in FIG. 5C and receives a Payment Status Response 520 as shown in FIG. 5C. The Payment Status Request 519 requests the Payment Status 810 as shown in FIG. 8 from the Server Payment Status Module 146, while the Payment Status Response 520 provides the Payment Status 810 value as requested by the Merchant Payment Status Module 172.

The server payment status module 146 communicates with the database 145 and the external Crypto-Currency Network 130 in order to gather appropriate information regarding the processed transaction in order to convey to an external merchant delivery system 180 an accurate delivery status related to the processed purchase transaction. The server payment status module 146 is configured to initialize a delivery status for the purchase transaction made by the customer 110 whereby the delivery status is reflective of the real-time status of the transaction in process. In one embodiment, the delivery status begins at “initialized”. When the payment is made by the customer 110 the blockchain confirmation count is 0, and the process of verifying and transferring blockchain confirmations to the intermediary wallet 149 begins. The delivery status is modified to “Not Ready for Delivery” when the blockchain confirmation count is 0 and this status of “Not Ready for Delivery” is maintained until the intermediary wallet 149 and the delivery status modules 148 both receive from the Crypto-Currency Network 130 a blockchain confirmation value of less than the Delivery Level 804 (as shown in FIG. 8) amount set in the PayByCrypto API previously received by the server payment module 142. The intermediary wallet 149 and the payment status module 146 gradually receives blockchain confirmations from the crypto currency network related to the purchase made by the customer 110 over a time range period, between a few minutes to a few hours with a typical minimum of 10 minutes and a maximum of 1 hour in duration. As the numbers of blockchain confirmations gradually received begin to accrue the delivery status is modified to reflect the real time delivery status of the purchase transaction. The delivery status may be incremented to “Ready for Delivery” at the moment when the number of confirmations in the blockchain has reached a value equal or greater to the Delivery Level 804 as shown in FIG. 8. When all required confirmations on the blockchain are received (typically 6 for Bitcoin), then the Delivery status is fixed to “Ready for Delivery”.

In order for the external Merchant Delivery System 182 to know that the delivery status value 812 as shown in FIG. 8, the Merchant Delivery Status Module 182 uses a Delivery Status API 188 to transmits a Delivery Status Request 521 as shown in FIG. 5C and receives a Delivery Status Response 522 as shown in FIG. 5C. The Delivery Status Request 521 requests the Delivery Status 812 as shown in FIG. 8 from the Merchant Payment Status Module 172, while the Delivery Status Response 522 provides the Delivery Status 812 value as requested by the Merchant Delivery Status Module 182.

FIG. 4 is a sequence diagram illustration one embodiment of the payment status of the Dynamic Delivery Authorization System for Cryptographic Payments. In one exemplary embodiment of the disclosure, the customer wants to make a purchase 401 and using the merchant payment module 122 a request is sent from the merchant payment module 122 to the server payment module 142, the server payment module 142 responds with redirect the customer to Cashier System page 403. In the meantime, in the background, the server payment module 142 will transmit a request quote request 406 to cryptographic exchange 150 and will receive a response quote 407 in response thereto. Then, the server payment module 142 will display a quote to the client 408 which represents the legal tender value to crypto currency conversion value so that the customer is aware of the actual crypto-currency value which will be deducted from his crypto wallet as shown in FIG. 3A. Thereafter, the customer agrees to the Cashier Page terms and conditions by clicking a checkbox, which automatically triggers a call to the server payment module, a T/C Request 409, and is quickly responded to by the server payment module 142 by means of a T/C Response 410.

Automatically, upon agreement to the T/C and receipt of the T/C Request 409 by the Server Payment Module 142, an update request 410 is transmitted from the Server Payment Module 142 to the Server Payment Status Module 146 in order to increment 531 the Payment Status 810 value from “null” to “Awaiting Payment” 440. At this point, if the Merchant Payment Status Module inquired about the payment status, it has the ability to transmit a Payment Status Request 412 call, and receive a Payment Status Response 413 call back including the “Awaiting Payment” payment status 810 value. Thereafter, the customer provides his cryptographic private key associated to his cryptographic payment wallet in order to authorize the purchase will trigger a PayByCrypto Request 414 API call from the Merchant Payment Module 122 to the Server Payment Module 142 containing Authorization Level 802 value which is the number of confirmation in the crypto currency blockchain required in order for the cryptographic payment to be deemed as trustworthy and authorized by an external Merchant Payment System 172. Upon receiving the PayByCrypto Request 414 the Server Payment Module 142 will initiate 415 a call to the Crypto-Currency Network 130 to initiate the verification and transfer of crypto currency confirmation to be directed towards its intermediary wallet 149 (not shown). The Crypto-Currency Network 130 will transmit a Response 416 back to the Server Payment Module to fulfill the initiate 415 request it received. Thereafter, the Server Payment Module 142 will transmit a PayByCrypto Response 417 back to the Merchant Payment Module 417 informing the customer that the transaction is completed. Upon payment by the customer being deemed in process the Server Payment Module 142 will transmit an update request 418 to the Server Payment Status Module so that the payment status 810 value is incremented from “awaiting payment” 440 to “payment made” 450. Moreover, the Crypto-Currency Network 130 will continue to submit to the Server Payment Status Module 149 blockchain confirmations it receives from miners via an update request 419, and when this occurs the payment status 810 value may be incremented based upon the threshold value previously set by the PayByCrypto Request 414 which preconfigured the “Authorization Level” 802 for the payment status to be deemed as “authorized”. If the number of blockchain confirmations received is less than the “authorization level” 802 then the payment status 810 will remain in the “Payment Made” 450. If the number of blockchain confirmations received is equal or greater than the “authorization level” 802 then the payment status 810 will be incremented to “Authorized” 606. The external Merchant Payment Status Module 172 may request the payment status 810 value by transmitting a Payment Status Request 420 and receive a Payment Status Response 421 which will include the payment status 810 value.

FIG. 5A is a sequence diagram illustrating the first embodiment of the Dynamic Delivery Authorization System for Cryptographic Payments. FIG. 5A may intentionally not illustrate or describe a few message calls that were described in FIG. 4 in order to avoid repetitiveness. In one embodiment of the disclosure, the customer 110 wants to pay for a tangible or intangible item by means of crypto currency 501 by using the Merchant Payment Module 122. The customer transmits a request to the Server Payment Module 142 displaying the purchase amount in legal tender value to retrieve the currency exchange value for the purchase amount in crypto currency type selected by the customer (i.e. Bitcoin) in real time from the Server Payment Module 142. The Server Payment Module 142 will Request a Quote 406 from the Crypto Exchange 150 receive a Response Quote 407 from the Crypto Exchange 150. The Server Payment Module 142 will analyze the results from the Crypto Exchange 150 and present to the customer 110 the exchange value (received from multiple crypto exchanges) that is most favorable to the customer. The Server Payment Module 142 will transmit a Display Currency Conversion Request message 408 to the Merchant Payment Module 122 so that the Customer is able to view the actual crypto currency cost associated with the identified purchase. The Customer 110 is then able to agree to the Terms and Conditions by sending a T/C Response 502 from the Merchant Payment Module to the Server Payment Module 142 and receive a T/C Response 503. The Customer 110 enters his private keys associated with the customer crypto currency wallet 112 to authorize the transfer of crypto currency from the customer crypto currency wallet 112 to an intermediary wallet 149 (not shown). When the Customer 110 authorizes the transfer of crypto currency a simultaneous PayByCrypto Request 414 is transmitted to the Server Payment Module 142 indicating, among other things, that the Customer 110 has made a payment using crypto currency that will be monitored. Upon receiving the PayByCrypto Request 414 the Server Payment Module 142 will initiate 415 a call to the Crypto-Currency Network 130 to initiate the verification and transfer of crypto currency confirmation to be directed towards its intermediary wallet 149 (not shown). The Crypto-Currency Network 130 will transmit a Response 416 back to the Server Payment Module to fulfill the initiate 415 request it received. Thereafter, the Server Payment Module 142 will transmit a PayByCrypto Response 417 back to the Merchant Payment Module 417 informing the customer that the transaction is completed. The crypto currency network 130 will continue to transmit several update 504 requests to the Server Payment Status Module, as well as other modules within the crypto currency payment system 140, in order to inform the Server Payment Status Module 146 to increment 533 its Payment Status 810 value as confirmations from the blockchain are accrued over time. In a similar way, the crypto currency network 130 will continue to transmit several update 505 requests to the Server Delivery Status Module 148, as well as other modules within the crypto currency payment system 140, in order to inform the Server Delivery Status Module 148 to increment 53 it Delivery Status 812 value as confirmations from the blockchain are accrued over time. The Merchant Payment Status Module 172 may transmit a Payment Status Request 506 via a PaymentStatus API call (as described in FIG. 8) in order to inquire in regards to the most up to date Payment Status 810 value captured by the Server Payment Status Module 146. In response, the Server Payment Status Module 146 will transmit a Payment Status Response 507 message containing the Payment Status 810 value, as well as other detailed information, for which the Merchant Payment Status Module 172 inquired in regards. Similarly, the Merchant Delivery Status Module 182 may transmit a Delivery Status Request 508 via a DeliveryStatus API call (as described in FIG. 8) in order to inquire in regards to the most up to date Delivery Status 812 value captured by the Server Delivery Status Module 148. In response, the Server Delivery Status Module 148 will transmit a Delivery Status Response 509 message containing the Delivery Status 812 value, as well as other detailed information, for which the Merchant Delivery Status Module 172 inquired in regards. As time accrues past the initial purchase of the Customer 110, the Crypto Currency Network 130 will continue to verify for transfer confirmation on the blockchain and successfully notify the intermediary wallet 149, the Server Payment Status Module 146, and the Server Delivery Status Module 148 in regards to the confirmations being received for the purchase completed by the Customer 110. As these confirmations continue to come in, the Server Payment Status Module 146 will continue to increment 535 its Payment Status 810 value from one status value to the next depending on meeting preconfigured thresholds setup by the merchant. In one embodiment of the disclosed system, the Merchant Payment Status Module 172 may ping the Server Payment Status Module 146 every minute in order to get a real-time Payment Status 810 value until the transaction is deemed Settled, for which at this point, the Merchant Payment Status Module 172 may discontinue its inquire regarding the Payment Status 810 value of the specified transaction associated to the Customer 110 purchase completed. This is shown in Payment Status Request 510 and Payment Status Response 511 in FIG. 5A. Similarly, in one embodiment of the disclosed system, the Merchant Delivery Status Module 182 may ping the Server Delivery Status Module 148 every minute in order to get a real-time Delivery Status 812 value until the transaction is deemed as “Ready for Delivery”, for which at this point, the Merchant Delivery Status Module 148 will discontinue its inquire regarding the Delivery Status 812 value of the specified transaction associated to the Customer 110 purchase completed. This is shown in Delivery Status Request 508 and Delivery Status Response 509 in FIG. 5A. Thereafter, as the Payment Status is set to “Cleared” then a process of settlement is initiated whereby a Settlement Request 512/Settlement Response 513 is transmitted from and to the Server Payment Status Module 146 to the Crypto Exchange 150, then to the Intermediary Bank 160, and finally transferred to the Merchant Bank 164. Additionally, the Merchant may opt to maintain the funds in crypto currency, whereby the intermediary wallet 149 will transfer the crypto currency value to the merchant wallet 176 via a Crypto Currency Settlement 147 API call.

FIG. 5B is a sequence diagram illustrating the second embodiment of the Dynamic Delivery Authorization System for Cryptographic Payments. FIG. 5B may intentionally not illustrate or describe a few message calls that were described in FIG. 4 in order to avoid repetitiveness. In one embodiment of the disclosure, the customer 110 wants to pay for a tangible or intangible item by means of crypto currency 501 by using the Merchant Payment Module 122. The customer transmits a request to the Server Payment Module 142 displaying the purchase amount in legal tender value to retrieve the currency exchange value for the purchase amount in crypto currency type selected by the customer (i.e. Bitcoin) in real time from the Server Payment Module 142. The Server Payment Module 142 will Request a Quote 406 from the Crypto Exchange 150 receive a Response Quote 407 from the Crypto Exchange 150. The Server Payment Module 142 will analyze the results from the Crypto Exchange 150 and present to the customer 110 the exchange value (received from multiple financial institutions) that is most favorable to the customer. The Server Payment Module 142 will transmit a Display Currency Conversion Request message 408 to the Merchant Payment Module 122 so that the Customer is able to view the actual crypto currency cost associated with the identified purchase. The Customer 110 is then able to agree to the Terms and Conditions by sending a T/C Response 502 from the Merchant Payment Module to the Server Payment Module 142 and receive a T/C Response 503. The Customer 110 enters his private keys associated with the customer crypto currency wallet 112 to authorize the transfer of crypto currency from the customer crypto currency wallet 112 to an intermediary wallet 149 (not shown). When the Customer 110 authorizes the transfer of crypto currency a simultaneous PayByCrypto Request 414 is transmitted to the Server Payment Module 142 indicating, among other things, that the Customer 110 has made a payment using crypto currency that will be monitored. Upon receiving the PayByCrypto Request 414 the Server Payment Module 142 will initiate 415 a call to the Crypto-Currency Network 130 to initiate the verification and transfer of crypto currency confirmation to be directed towards its intermediary wallet 149 (not shown). The Crypto-Currency Network 130 will transmit a Response 416 back to the Server Payment Module to fulfill the initiate 415 request it received. Thereafter, the Server Payment Module 142 will transmit a PayByCrypto Response 417 back to the Merchant Payment Module 417 informing the customer that the transaction is completed. The crypto currency network 130 will continue to transmit several update 504 requests to the Server Payment Status Module, as well as other modules within the crypto currency payment system 140, in order to inform the Server Payment Status Module 146 to increment 533 its Payment Status 810 value as confirmations from the blockchain are accrued over time. The Merchant Payment Status Module 172 may transmit a Payment Status Request 506 via a PaymentStatus API call (as described in FIG. 8) in order to inquire in regards to the most up to date Payment Status 810 value captured by the Server Payment Status Module 146. In response, the Server Payment Status Module 146 will transmit a Payment Status Response 507 message containing the Payment Status 810 value, as well as other detailed information, for which the Merchant Payment Status Module 172 inquired in regards. Similarly, the Merchant Delivery Status Module 182 may transmit a Delivery Status Request 517 via a DeliveryStatus API call (as described in FIG. 8) in order to inquire in regards to the most up to date Delivery Status 812 value captured by the Server Payment Status Module 146. In response, the Server Payment Status Module 146 will transmit a Delivery Status Response 518 message containing the Delivery Status 812 value, as well as other detailed information, for which the Merchant Delivery Status Module 172 inquired in regards. In one embodiment of the disclosed system, the Merchant Payment Status Module 172 may ping the Server Payment Status Module 146 every minute in order to get a real-time Payment Status 810 value until the transaction is deemed Settled. This is shown in Payment Status Request 506 and Payment Status Response 507 in FIG. 5B. Similarly, in one embodiment of the disclosed system, the Merchant Delivery Status Module 182 may ping the Server Payment Status Module 146 every minute in order to get a real-time Delivery Status 812 value until the transaction is deemed as “Ready for Delivery”. This is shown in Delivery Status Request 517 and Delivery Status Response 518 in FIG. 5B.

FIG. 5C is a sequence diagram illustrating the third embodiment of the Dynamic Delivery Authorization System for Cryptographic Payments. FIG. 5B may intentionally not illustrate or describe a few message calls that were described in FIG. 4 in order to avoid repetitiveness. In one embodiment of the disclosure, the customer 110 wants to pay for a tangible or intangible item by means of crypto currency 501 by using the Merchant Payment Module 122. The customer transmits a request to the Server Payment Module 142 displaying the purchase amount in legal tender value to retrieve the currency exchange value for the purchase amount in crypto currency type selected by the customer (i.e. Bitcoin) in real time from the Server Payment Module 142. The Server Payment Module 142 will Request a Quote 406 from the Crypto Exchange 150 receive a Response Quote 407 from the Crypto Exchange 150. The Server Payment Module 142 will analyze the results from the Crypto Exchange 150 and present to the customer 110 the exchange value (received from multiple financial institutions) that is most favorable to the customer. The Server Payment Module 142 will transmit a Display Currency Conversion Request message 408 to the Merchant Payment Module 122 so that the Customer is able to view the actual crypto currency cost associated with the identified purchase. The Customer 110 is then able to agree to the Terms and Conditions by sending a T/C Response 502 from the Merchant Payment Module to the Server Payment Module 142 and receive a T/C Response 503. The Customer 110 enters his private keys associated with the customer crypto currency wallet 112 to authorize the transfer of crypto currency from the customer crypto currency wallet 112 to an intermediary wallet 149 (not shown). When the Customer 110 authorizes the transfer of crypto currency a simultaneous PayByCrypto Request 414 is transmitted to the Server Payment Module 142 indicating, among other things, that the Customer 110 has made a payment using crypto currency that will be monitored. Upon receiving the PayByCrypto Request 414 the Server Payment Module 142 will initiate 415 a call to the Crypto-Currency Network 130 to initiate the verification and transfer of crypto currency confirmation to be directed towards its intermediary wallet 149 (not shown). The Crypto-Currency Network 130 will transmit a Response 416 back to the Server Payment Module to fulfill the initiate 415 request it received. Thereafter, the Server Payment Module 142 will transmit a PayByCrypto Response 417 back to the Merchant Payment Module 417 informing the customer that the transaction is completed. The crypto currency network 130 will continue to transmit several update 504 requests to the Server Payment Status Module, as well as other modules within the crypto currency payment system 140, in order to inform the Server Payment Status Module 146 to increment 533 its Payment Status 810 value as confirmations from the blockchain are accrued over time. The Merchant Payment Status Module 172 may transmit a Payment Status Request 506 via a PaymentStatus API call (as described in FIG. 8) in order to inquire in regards to the most up to date Payment Status 810 value captured by the Server Payment Status Module 146. In response, the Server Payment Status Module 146 will transmit a Payment Status Response 507 message containing the Payment Status 810 value, as well as other detailed information, for which the Merchant Payment Status Module 172 inquired in regards. Similarly, the Merchant Delivery Status Module 182 may transmit a Delivery Status Request 521 via a DeliveryStatus API call (as described in FIG. 8) in order to inquire in regards to the most up to date Delivery Status 812 value captured by the Merchant Payment Status Module 172. In response, the Merchant Payment Status Module 172 will transmit a Delivery Status Response 522 message containing the Delivery Status 812 value, as well as other detailed information, for which the Merchant Delivery Status Module 182 inquired in regards. In one embodiment of the disclosed system, the Merchant Payment Status Module 172 may ping the Server Payment Status Module 146 every minute in order to get a real-time Payment Status 810 value until the transaction is deemed Settled. This is shown in Payment Status Request 506 and Payment Status Response 507 in FIG. 5C. Similarly, in one embodiment of the disclosed system, the Merchant Delivery Status Module 182 may ping the Merchant Payment Status Module 172 every minute in order to get a real-time Delivery Status 812 value until the transaction is deemed as “Ready for Delivery”. This is shown in Delivery Status Request 521 and Delivery Status Response 522 in FIG. 5B.

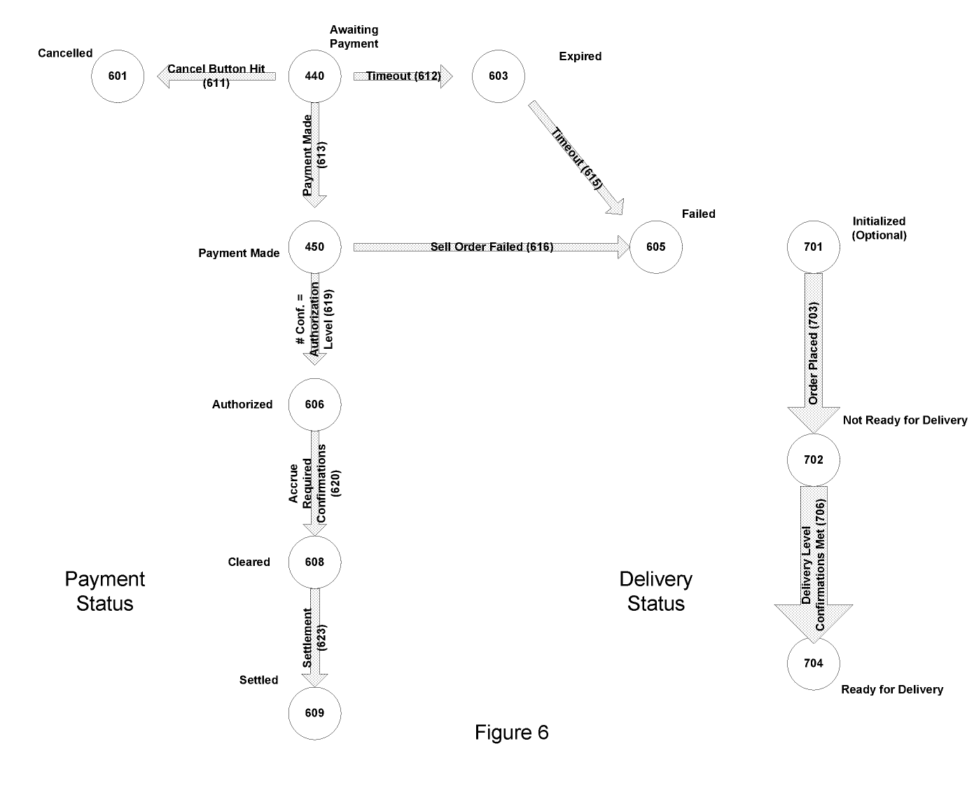

FIG. 6 illustrates an exemplary payment status and delivery status process flow diagram. In one embodiment of the disclosure the payment status process flow begins in the “awaiting payment” status 440 where the purchaser has accepted the terms and conditions and is going to pay for his purchase using crypto currency payment method. The “awaiting payment” status 440 may be modified if a “payment made” event 613 is completed by the purchaser changing the payment status 810 to “payment made” status 450. In “payment made” status 450 the payment was completed by the purchaser entering his private keys to initiate the payment transfer and the number of blockchain confirmations is less than “authorization level” 802 parameter value. Also, the “awaiting payment” status 440 may be modified if a “timeout” event 612 takes place where the purchaser changes his mind and decides to not make the purchase (non-responsive) changing the payment status 810 to “expired” status 603. Also, the “awaiting payment” 440 status may be modified if a “cancel button hit” event 611 takes place where the purchaser changes his mind and decides to not make the purchase changing the payment status 810 to “cancelled” 601. The “expired” 603 payment status may by modified by a “timeout” event 615 where the transaction is timed out by the transaction server for being non-responsive for a set time period, thus changing the payment status 810 to “failed” status 605. Once in the “payment made” status 450 the number of confirmations on the blockchain begins at 0 and increments over a time period as the miners within the crypto currency network verify the transaction which may take several hours depending on the crypto currency network being used by the purchaser. The payment status 810 will remain in “payment made” status as long as the blockchain confirmation value received from the crypto network is less than the “authorized” level 802 set within the PayByCrypto API parameters. If during the “payment made” event 613 the “sell order failed” event 616 is triggered indicating the transaction with the crypto exchange was unsuccessful then the payment status 810 is changed to “failed” status 605. Once the number of blockchain confirmations received is equal to the “authorized” level 802 set within the PayByCrypto API parameters, then the “# of confirmations=authorization level” event 619 takes place and changes the payment status to “authorized” status 606. The payment status 810 will remain in the “authorized” status 606 until all required blockchain confirmations from the crypto currency network are all received in which case an “accrue required confirmations” event 620 takes place and changes the payment status to “cleared” 608. The “cleared” status 608 indicates that the payment was successful and will be settled. Once a “settlement” event 623 takes place, then the payment status 810 is changed to “settled” status 609.

In one embodiment of the disclosure the delivery status process flow begins in the “initialized” delivery status 701 where the purchaser is displayed with the currency conversion values in order to pay using crypto currency and desires to pay for his purchase using crypto currency payment method. The “initialized” status 701 may be modified if a “order placed” event 703 is completed by the purchaser changing the delivery status 812 to “Not Ready for Delivery” status 702. The “Not Ready for Delivery” status 702 indicates that the number of confirmations in the blockchain has not been reached for “Delivery Level” 801 previously set in PayByCrypto API (or backend system). Once the number of blockchain confirmations received from the crypto currency network is equal to or greater than the “Delivery Level” 804 value previously set, then a “Delivery Level Confirmations Met” event 706 takes place and as a result modifies the delivery status 812 from “Not Ready for Delivery” status 702 to “Ready for Delivery” status 704. The “Ready for Delivery” status 704 indicates that the number of confirmations in the blockchain has been reached for “Delivery Level” 804 previously set in PayByCrypto API (or backend system).

In one embodiment of the disclosure the payment status may be set to “Payment Made” status 450 as soon as the customer 110 enters the private key into the crypto wallet 112. The crypto currency network 130 acknowledges the transaction in this very moment. There is an undefined time period between the “payment made” status 450 and the first confirmation from crypto miners verifying the uniqueness of the transaction. It might be a fraction of a second or a few hours depending on the condition of the crypto network. Normally, it takes 10 minutes; while 6 confirmations usually taking 1 h. 6 confirmations are regarded as waterproof (impossible to reverse the transaction). A transaction is broadcasted to the network in case of (0) zero confirmation, but in the case of (1) one confirmation, transaction is included into a block of the crypto network, hence, making it a chain when more confirmations follow.

Once the delivery status 812 value is set to “Ready for Delivery” delivery status 704 the customer 110 payment is deemed as trustworthy for delivery. In this very moment, the merchant delivers products or services to the customer 110 by releasing virtual goods or services via digital distribution channels, delivering goods and services offline, or shipping of physical goods via logistics provider.

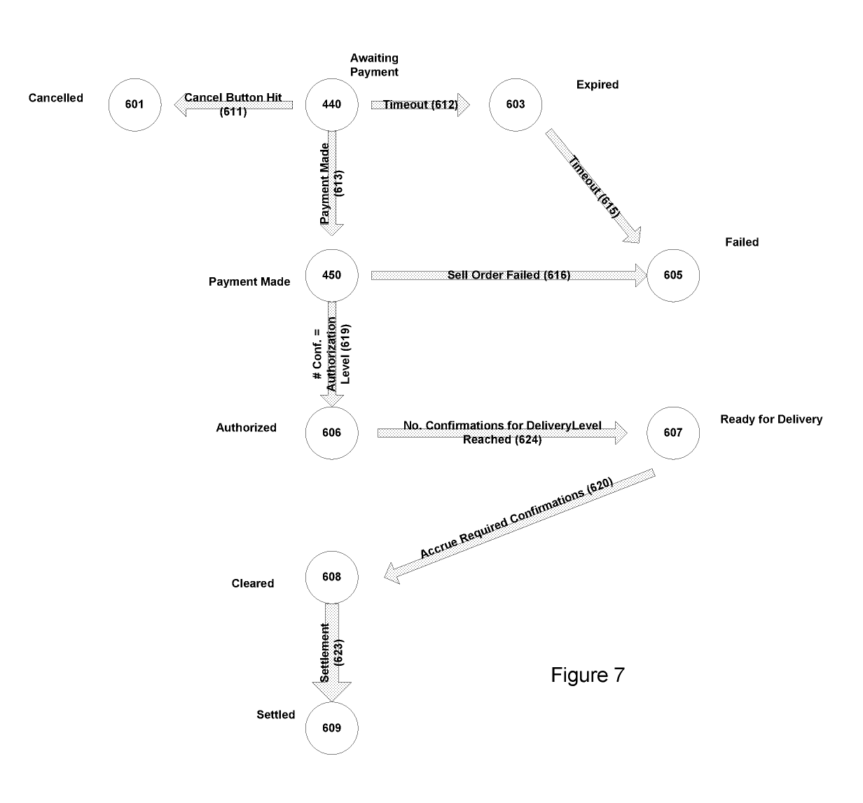

FIG. 7 illustrates an exemplary payment status with integrated delivery status process flow diagram. In one embodiment of the disclosure the payment status process flow begins in the “awaiting payment” status 440 where the purchaser has accepted the terms and conditions and is going to pay for his purchase using crypto currency payment method. The “awaiting payment” status 440 may be modified if a “payment made” event 613 is completed by the purchaser changing the payment status 810 to “payment made” status 450. In “payment made” status 450 the payment was completed by the purchaser entering his private keys to initiate the payment transfer and the number of blockchain confirmations is less than “authorization level” 802 parameter value. Also, the “awaiting payment” status 440 may be modified if a “timeout” event 612 takes place where the purchaser changes his mind and decides to not make the purchase (non-responsive) changing the payment status 810 to “expired” status 603. Also, the “awaiting payment” status 440 may be modified if a “cancel button hit” event 611 takes place where the purchaser changes his mind and decides to not make the purchase changing the payment status 810 to “cancelled” 601. The “expired” 603 payment status may by modified by a “timeout” event 615 where the transaction is timed out by the transaction server for being non-responsive for a set time period, thus changing the payment status 810 to “failed” status 605. Once in the “payment made” status 450 the number of confirmations on the blockchain begins at 0 and increments over a time period as the miners within the crypto currency network verify the transaction which may take several hours depending on the crypto currency network being used by the purchaser. The payment status 810 will remain in “payment made” status as long as the blockchain confirmation value received from the crypto network is less than the “authorized” level 802 set within the PayByCrypto API parameters. If during the “payment made” event 613 the “sell order failed” event 616 is triggered indicating the transaction with the crypto exchange was unsuccessful then the payment status 810 is changed to “failed” status 605. Once the number of blockchain confirmations received is equal to the “authorized” level 802 set within the PayByCrypto API parameters, then the “# of confirmations=authorization level” event 619 takes place and changes the payment status to “authorized” status 606. The payment status 810 will remain in the “authorized” status 606 until a “n” number of confirmations for Delivery Level is reached” event 624 takes place and changes to “Ready for Delivery” payment status 607. Once the payment status is in the “Ready for Delivery” payment status 607 the blockchain confirmations continue to accrue until the “Accrue Required Confirmations” status 620 even 620 is reached whereby all required blockchain confirmations related to the purchase transaction are finally confirmed, then the payment status will be modified to “Cleared” status 608. The “cleared” status 608 indicates that the payment was successful and will be settled. Once a “settlement” event 623 takes place, then the payment status 810 is changed to “settled” status 609.

FIG. 8 is an illustrative block diagram of the a few parameters which can be found within the PayByCrypto API, the Payment Status API, and the Delivery Status API.

The PayByCrypto API may include an “Authorization Level” 802 parameter value which indicates the number of confirmations in the crypto currency blockchain to be received until the payment status may be modified to “Authorized” payment status 606. The PayByCrypto API may include a “Delivery Level” 804 parameter value which indicates the number of confirmations in the crypto currency blockchain to be received until the payment status 810 or delivery status 812 may be modified to “Ready for Delivery” payment status 607 or “Ready for Delivery” delivery status 704.

The Payment Status API may include a “Payment Status” 810 parameter value which indicates the actual payment status in real time as maintained by the server payment status module 146. The “payment status” 810 value is an adjusted value which takes into consideration that a customer payment has been made, that the crypto network 130 is delivering blockchain confirmations in response to customer payment requests and adjust the payment status in accordance with logical framework explained in FIG. 6 and FIG. 7. The payment status 810 may have an “awaiting payment” status 440 value in the event that the purchaser has accepted the terms & conditions and is going to pay. The payment status 810 may have a “payment made” status 450 in the event that the payment was initialized and the number of blockchain confirmations is less than “Authorization Level”. The payment status 810 may have a “authorized” status 606 in the event that the number of confirmations in the blockchain has been reached for “Authorization Level” previously set in PayByCrypto API (or backend system). The payment status may have a “Ready for Delivery” payment status 607 in the event that the number of confirmations in the blockchain has been reached for “Delivery Level” previously set in PayByCrypto API (or backend system). The payment status 810 may have a “cleared” status 608 in the event that the payment was successful and will be settled. The payment status 810 may have a “settled” status 609 in the event that the payment was settled. The payment status 810 will have a “expired” status 603 in the event that the payment has expired. The payment status 810 will have a “cancelled” status 601 in the event that the payment has been cancelled by the purchaser. The payment status 810 will have a “failed” status 605 in the event that the payment has been failed for other reasons.

The Delivery Status API may include a “Delivery Status” 812 parameter value which indicates the actual payment status in real time as maintained by the server delivery status module 148. The “delivery status” 812 value is an adjusted value which takes into consideration that a customer payment has been made, that the crypto network 130 is delivering blockchain confirmations in response to customer payment requests and adjust the payment status in accordance with logical framework explained in FIG. 6. The delivery status 812 may have an “initialized” delivery status 701 value in the event that the payment has been initialized by the server 140. The delivery status 812 may have an “Not Ready for Delivery” status 702 in the event that the number of confirmation in the blockchain has not been reached for “Delivery Level” previously set in PayByCrypto API (or backend system). The delivery status 812 may have a “Ready for Delivery” status 704 in the event that the number of confirmations in the blockchain has been reached for “Delivery Level” previously set in PayByCrypto API (or backend system).

Delivery Status API may include a Delivery Status of “Initialized”: The payment has been initialized, “Not Ready for Delivery”: The number of confirmation in the blockchain has not been reached for “Delivery Level” previously set in the PayByCrypto API (or backend system configuration), or “Ready for Delivery”: The number of confirmation in the blockchain has been reached for “Delivery Level” previously set in PayByCrypto API (or backend system configuration).

Delivery Status API may include a Delivery Event. Delivery Events are generated by specific integrations in relation to the merchant delivery system when specific delivery events happen, such as reaching a specific inventory level and/or the creation of a fulfillment or shipping status, and/or the attainment of a particular delivery risk.

Delivery Status API may include a Delivery Risk Event. The Delivery risk assessment is used to indicate to a merchant the fraud checks that have been done on a cryptographic payment from a specific user.

Delivery Status API may include a Fulfillment Service Event. Using the Fulfillment Service Event, merchants can register, edit and delete a new fulfillment service. A Fulfillment Service is a third party warehouse that prepares and ships orders on behalf of the merchant. Fulfillment services charge a fee to package and ship items and update product inventory levels. Some well-known fulfillment services that could benefit from “Dynamic Delivery Authorization System for Cryptographic Payments” integrations include Amazon or Shipwire.

A Fulfillment Service Event, “Dynamic Delivery Authorization System for Cryptographic Payments” can retrieve inventory levels.

“Dynamic Delivery Authorization System for Cryptographic Payments” will make a request for the inventory of an individual SKU when the product is set up initially or is changed in the Merchant's Admin. A request for all inventory data will happen once every hour to keep our system up to date with the remote fulfillment service.

A sample for inventory levels:

GET /fetch_stock
Get inventory levels for a particular SKU.
https://myapp.com/fetch_stock.json?sku=123&merchant=testmerchant
Response

{“123”: 1000}

Delivery Status API may include a Consignment Event. A consignment represents a shipment of one or more items in an order. When we say that an order has been completely fulfilled, we mean that all the items that make up that order have been sent to the customer.

### Sample Query:

### Get Consignment Packaging Status

### Get Consignment Shipping Status

### Response:

Handling in Progress/Distribution Center reached

### Complete or Partial Delivery

increment

Delivery Status API may include a Tracking Event. A tracking event belongs to a fulfillment of one or more items in an order.

In this event, “Dynamic Delivery Authorization System for Cryptographic Payments” can retrieve tracking numbers for orders.

On a regular basis, the Payment21®-API will make a request to this endpoint if there are any completed fulfillments awaiting tracking numbers from the remote fulfillment service. A sample request for tracking numbers:

GET /fetch_tracking_numbers
Get tracking numbers for orders

| | |
|---|---|
| order_ids | The order names we require tracking numbers for (i.e. |
| | #1001) |
| order_names | The order names we require tracking numbers for (i.e. |
| | #1001) |
| merchant | The merchant's url |

Get a list of tracking numbers for the following order IDs.

http://myapp.com/fetch_tracking_numbers.json?order_ids[
]=#1001&order_ids[ ]=#1002&ord
er_ids[ ]=#1003&order_names[ ]=#1001&order_names[
]=#1002&order_names[ ]=#1003
Response

{ “tracking_numbers”: {

“#1001”: “qwerty”,
“#1002”: “asdfg”,
“#1003”: “zxcvb”

},

“message”: “Successfully received the tracking numbers”,
“success”: true
}

Delivery Status API may include a Carrier Service Event. A Carrier Service (also known as a Carrier Calculated Service or Shipping Service) provides real-time shipping rates to “Payment21® Dynamic Delivery Authorization System for Cryptographic Payments”. Some common carrier services include: FedEx, USPS and UPS.

Although this invention has been described in terms of certain preferred embodiments, other embodiments that are apparent to those of ordinary skill in the art, including embodiments which do not provide all of the benefits and features set forth herein, are also within the scope of this invention. Accordingly, the scope of the present invention is defined only be reference to the appended claims.

What is claimed is:

1. a dynamic delivery authorization system for cryptographic payment comprising:
a server payment module configured to:
permit a user to make a purchase order using crypto currency stored in a crypto wallet of a user to a merchant payment module which transmits a crypto payment request to a cryptographic payment server payment module, wherein the crypto payment request comprising:
a payment authorization value identifying the number of blockchain confirmations value from a range 0 to n for the purchase in order to label the purchase as authorized by a merchant payment system; and
a delivery authorization value identifying the number of blockchain confirmations value from the range of 0 to n for the purchase in order to label the purchase as ready for delivery by the merchant delivery system;
the server payment status module configured to:
receive blockchain confirmations from cryptographic currency network;
modify a payment status value associated with the purchase upon accrual of the number of blockchain confirmations received;
receive a payment status request from the merchant payment system inquiring about the payment status value associated with the purchase and in response providing the payment status value;
a server delivery status module configured to:
receive blockchain confirmation from the cryptographic currency network;
modify a delivery status value associated with the purchase upon accrual of the number of blockchain confirmations received;
receive a delivery status request from the merchant delivery system inquiring about the delivery status value associated with the purchase and in response providing the delivery status value.

2. The system of claim 1, wherein the cryptographic currency network is a Bitcoin network.

3. The system of claim 1, wherein the delivery authorization value is between 0 and 6 blockchain confirmations.

4. The system of claim 1, wherein the payment status value is awaiting payment, payment made, authorized, ready for delivery, cleared, settled, expired, cancelled or failed.

5. The system of claim 1, wherein the delivery status value is initialized, not ready for delivery, or ready for delivery.

6. The system of claim 1, wherein the merchant delivery system is releasing at least one item identified by the purchase order in response to the delivery status value indicating the purchase as ready for delivery.

7. A computer implemented method of dynamic delivery authorization for cryptographic payments, the method comprising:
receiving from a merchant payment module a cryptographic payment request, the request comprising a delivery authorization value identifying a blockchain confirmation value dynamically configured by a merchant specific to the cryptographic payment request received;
receiving blockchain confirmations from a crypto-currency network in response to the payment request to the cryptographic payment request;
modifying a blockchain received status value associated to the cryptographic payment request upon accrual of the blockchain confirmations from the crypto-currency network;
receive delivery status request from a merchant payment system inquiring about the blockchain received status value associated with the cryptographic payment request and in response provide the blockchain received status value.

8. The computer implemented method of claim 7, wherein the cryptographic currency network is a Bitcoin network.

9. The computer implemented method of claim 7, wherein the delivery authorization value is between 0 and 6 blockchain confirmations.

10. The computer implemented method of claim 7, further comprising: assigning a blockchain received status value of initialized when a customer is contemplating a purchase.

11. The computer implemented method of claim 7, wherein the delivery status value is initialized, not ready for delivery, or ready for delivery.

12. The computer implemented method of claim 7, further comprising: assigning a blockchain received status value of ready for delivery upon the receipt of the blockchain confirmations from the crypto-currency network equal to the delivery authorization value;

13. The computer implemented method of claim 7, wherein the received status value is awaiting payment, payment made, authorized, ready for delivery, cleared, settled, expired, cancelled or failed.

14. The computer implemented method of claim 7, wherein the delivery status value is initialized, not ready for delivery, or ready for delivery.

15. A computer implemented method of dynamic delivery authorization for cryptographic payment comprising:
receiving from a merchant payment module a cryptographic payment request, the request comprising:
a payment authorization value identifying a blockchain confirmation value from a range of 0 to n dynamically configured by a merchant specific to the cryptographic payment request received;
a delivery authorization value identifying a blockchain confirmation value from a range of 0 to n dynamically configured by a merchant specific to the cryptographic payment request received;
receiving blockchain confirmations from a crypto currency network in association to the cryptographic payment request, and in parallel update both:
a blockchain received payment status value associated to the cryptographic payment request upon accrual of the blockchain confirmations from the crypto currency network; and
a blockchain received delivery payment status value associated to the cryptographic payment request upon accrual of the blockchain confirmations from the crypto currency network;
assigning a blockchain received payment status value of authorized upon the receipt of the blockchain confirmations from the crypto currency network equal to the payment authorization value;
assigning a blockchain received delivery status value of ready for delivery upon the receipt of the blockchain confirmations from the crypto currency network equal to the delivery authorization value;
receiving a payment status request from a merchant payment system inquiring about the blockchain received status value associated with the cryptographic payment request and in response provide the blockchain received status value;
receiving a delivery status request from a merchant delivery system inquiring about the blockchain received status value associated with the cryptographic payment request and in response provide the blockchain received status value;

16. The computer implemented method of claim 15, wherein the cryptographic currency network is a Bitcoin network.

17. The computer implemented method of claim 15, wherein the delivery authorization value is between 0 and 6 blockchain confirmations.

18. The computer implemented method of claim 15, wherein the payment status value is awaiting payment, payment made, authorized, ready for delivery, cleared, settled, expired, cancelled or failed.

19. The computer implemented method of claim 15, wherein the delivery status value is initialized, not ready for delivery, or ready for delivery.

20. The computer implemented method of claim 15, wherein the merchant delivery system is releasing at least one item identified by the purchase order in response to the delivery status value indicating the purchase as ready for delivery.
